(19) United States
(12) Patent Application Publication
(10) Pub. No.: US 2020/0012205 A1
(43) Pub. Date: Jan. 9, 2020

(54) ELECTROPHOTOGRAPHIC PHOTORECEPTOR, PROCESS CARTRIDGE, AND IMAGE FORMING APPARATUS

(71) Applicant: FUJI XEROX CO.,LTD., Tokyo (JP)

(72) Inventors: Yoichi KIGOSHI, Kanagawa (JP); Takeshi IWANAGA, Kanagawa (JP); Nobuyuki TORIGOE, Kanagawa (JP); Masaki HIRAKATA, Kanagawa (JP); Hideya KATSUHARA, Kanagawa (JP); Keisuke KUSANO, Kanagawa (JP)

(73) Assignee: FUJI XEROX CO.,LTD., Tokyo (JP)

(21) Appl. No.: 16/260,141

(22) Filed: Jan. 29, 2019

(30) Foreign Application Priority Data
Jul. 6, 2018 (JP) 2018-129103

(51) Int. Cl. G03G 5/043; G03G 5/05; G03G 21/18

(52) U.S. Cl. CPC G03G 5/0436; G03G 21/1814; G03G 5/0507

(57) ABSTRACT

An electrophotographic photoreceptor includes a conductive substrate; an undercoat layer on the conductive substrate; a charge generating layer on the undercoat layer; a charge transporting layer on the charge generating layer; and an inorganic protective layer on the charge transporting layer. The undercoat layer, the charge transporting layer, and the inorganic protective layer each have a film elastic modulus of 5 GPa or more.

### CROSS-REFERENCE TO RELATED APPLICATIONS

This application is based on and claims priority under 35 USC 119 from Japanese Patent Application No. 2018-129103 filed Jul. 6, 2018.

### BACKGROUND

### (i) Technical Field

The present disclosure relates to an electrophotographic photoreceptor, a process cartridge, and an image forming apparatus.

### (ii) Related Art

Japanese Patent No. 5994708 describes an electrophotographic photoreceptor that includes a conductive substrate, an organic photosensitive layer on the conductive substrate, and an inorganic protective layer disposed on the organic photosensitive layer so as to contact a surface of the organic photosensitive layer, in which the organic photosensitive layer contains a charge transporting material and silica particles having a volume-average particle diameter of 20 nm or more and 200 nm or less, the charge transporting material and the silica particles being contained in at least a region close to the surface in contact with the inorganic protective layer.

Japanese Patent No. 5509764 describes an electrophotographic photoreceptor that includes a substrate and, in the order from the substrate side, an undercoat layer, which is a vapor deposited film containing oxygen and gallium with a gallium content of 28 atom % or more and 40 atom % or less, and a photosensitive layer.

### SUMMARY

For example, in an electrophotographic photoreceptor that includes an inorganic protective layer, presence of a hard matter, such as a carrier, between the electrophotographic photoreceptor and a member in contact to the electrophotographic photoreceptor may cause dents in the inorganic protective layer.

Aspects of non-limiting embodiments of the present disclosure relate to an electrophotographic photoreceptor that includes an inorganic protective layer, in which occurrence of dents in the inorganic protective layer is suppressed compared to when the film elastic modulus of at least one of an undercoat layer, a charge transporting layer, and an inorganic protective layer is less than 5 GPa or when the undercoat layer contains a binder resin and metal oxide particles.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electrophotographic photoreceptor includes a conductive substrate; an undercoat layer on the conductive substrate; a charge generating layer on the undercoat layer; a charge transporting layer on the charge generating layer; and an inorganic protective layer on the charge transporting layer. The undercoat layer, the charge transporting layer, and the inorganic protective layer each have a film elastic modulus of 5 GPa or more.

### BRIEF DESCRIPTION OF THE DRAWINGS

Exemplary embodiments of the present disclosure will be described in detail based on the following figures, wherein:

FIG. 1 is a schematic cross-sectional view of one example of the layer structure of an electrophotographic photoreceptor of an exemplary embodiment;

FIGS. 2A and 2B are schematic diagrams illustrating one example of a film forming apparatus used in forming an inorganic protective layer of the electrophotographic photoreceptor of this exemplary embodiment;

FIG. 3 is a schematic diagram illustrating an example of a plasma generator used in forming the inorganic protective layer of the electrophotographic photoreceptor of this exemplary embodiment;

FIG. 4 is a schematic diagram illustrating one example of an image forming apparatus according to an exemplary embodiment; and

FIG. 5 is a schematic diagram illustrating another example of the image forming apparatus according to the exemplary embodiment.

### DETAILED DESCRIPTION

The exemplary embodiments of the present disclosure will now be described.

### Electrophotographic Photoreceptor

An electrophotographic photoreceptor of a first exemplary embodiment includes a conductive substrate, an undercoat layer on the conductive substrate, a charge generating layer on the undercoat layer, a charge transporting layer on the charge generating layer, and an inorganic protective layer on the charge transporting layer, in which the undercoat layer, the charge transporting layer, and the inorganic protective layer each have a film elastic modulus of 5 GPa or more.

An electrophotographic photoreceptor of a second exemplary embodiment includes a conductive substrate; an undercoat layer on the conductive substrate, the undercoat layer being formed of a metal oxide layer; a charge generating layer on the undercoat layer; a charge transporting layer on the charge generating layer, the charge transporting layer containing a binder resin, a charge transporting material, and silica particles; and an inorganic protective layer on the charge transporting layer, the inorganic protective layer being formed of a metal oxide layer.

In this description, the features common to the first exemplary embodiment and the second exemplary embodiment are generally referred to as the features of “the present exemplary embodiment”.

Heretofore, a technology of forming an inorganic protective layer on an organic photosensitive layer is known.

An organic photosensitive layer has flexibility and a tendency to readily deform whereas an inorganic protective layer is hard but has a tendency to exhibit poor toughness.

Thus, dents sometimes occur in the inorganic protective layer.

For example, in a developing step, when a carrier is scattered from a developing unit and adheres to the electrophotographic photoreceptor, the carrier adhering to the electrophotographic photoreceptor reaches the transfer position. At the transfer position, a pressing force is applied to the carrier nipped between the electrophotographic photoreceptor and the transfer unit. Thus, for example, the carrier sandwiched between the electrophotographic photoreceptor and the transfer unit is pressed against the inorganic protective layer, and dents (recesses) are formed in the inorganic protective layer.

The studies on suppressing occurrence of dents in the inorganic protective layer have been made, and two approaches have been found.

The first exemplary embodiment involves an electrophotographic photoreceptor that includes an undercoat layer, a charge generating layer, a charge transporting layer, and an inorganic protective layer that are disposed on a conductive substrate in that order, and the undercoat layer, the charge transporting layer, and the inorganic protective layer each have a film elastic modulus of 5 GPa or more.

In the first exemplary embodiment, three layers, namely, the undercoat layer, the charge transporting layer, and the inorganic protective layer, which are relatively thick and have hardness having influence, each have a film elastic modulus of 5 GPa or more. Presumably due to this, not only the inorganic protective layer but three high-hardness layers including the inorganic protective layer enhance the mechanical strength of the electrophotographic photoreceptor, and thus occurrence of dents can be suppressed.

The second exemplary embodiment involves an electrophotographic photoreceptor that includes an undercoat layer, a charge generating layer, a charge transporting layer, and an inorganic protective layer that are disposed on a conductive substrate in that order, in which the undercoat layer and the inorganic protective layer are each formed of a metal oxide layer, and the charge transporting layer contains a binder resin, a charge transporting material, and silica particles.

In the second exemplary embodiment, three layers, namely, the undercoat layer, the charge transporting layer, and the inorganic protective layer, which are relatively thick and have hardness having influence, are each formed of a metal oxide layer or a layer containing silica particles. Presumably due to composition, the hardness of the three layers, namely, the undercoat layer, the charge transporting layer, and the inorganic protective layer, is enhanced, and these three high-hardness layers can enhance the mechanical strength of the electrophotographic photoreceptor. Thus, occurrence of dents can be suppressed.

In view of the above, it is presumed that due to the aforementioned features of the electrophotographic photoreceptor of the present exemplary embodiment (first exemplary embodiment and second exemplary embodiment), occurrence of dents is suppressed.

The method for measuring the film elastic modulus of each layer will now be described.

The film elastic modulus of each layer is determined by obtaining a depth profile with Nano Indenter SA2 produced by MTS Systems Corporation by continuous stiffness measurement (CSM) (U.S. Pat. No. 4,848,141) and calculating the average of values observed at an indentation depth of 30 nm to 2000 nm. The measurement conditions are as follows.
Measurement environment: 23° C., 55% RH
Indenter used: diamond regular three-sided pyramid indenter (Berkovic indenter)
Test mode: CSM mode

The measurement sample may be prepared by forming, on a substrate, layers to be measured, namely, an undercoat layer, a charge transporting layer, and an inorganic protective layer, under the same conditions as those for forming these layers. Alternatively, the sample may be prepared by taking out the undercoat layer, the charge transporting layer, and the inorganic protective layer from an already made electrophotographic photoreceptor. The obtained sample may be partly etched.

The following procedure is performed to measure the film elastic moduli of the undercoat layer, the charge transporting layer, and the inorganic protective layer from an already made electrophotographic photoreceptor.

First, the film elastic modulus of the inorganic protective layer is measured, and then the inorganic protective layer is removed by polishing, tape peeling, or the like. Then, the film elastic modulus of the exposed charge transporting layer is measured, and, after the measurement, the charge transporting layer and the charge generating layer (and, if necessary, the intermediate layer) are removed by, for example, immersing in an organic solvent, such as tetrahydrofuran, to dissolve. Then, the film elastic modulus of the exposed undercoat layer is measured.

The undercoat layer, the charge transporting layer, and the inorganic protective layer to be measured may be partly cut out with a cutter or the like to prepare measurement samples.

In the first exemplary embodiment, in order to more effectively suppress occurrence of dents in the inorganic protective layer, the difference in film elastic modulus between the undercoat layer and the inorganic protective layer may be 60 GPa or less, may be 50 GPa or less, or may be 40 GPa or less. In other words, the difference in film elastic modulus between the undercoat layer and the inorganic protective layer may be small. This is because the difference in film elastic modulus leads to recesses in the inorganic protective layer.

Moreover, in order to more effectively suppress occurrence of dents in the inorganic protective layer, the difference in film elastic modulus between the charge transporting layer and the inorganic protective layer may also be 90 GPa or less.

In the present exemplary embodiment, the difference in film elastic modulus between the undercoat layer, the charge generating layer, the charge transporting layer, and the inorganic protective layer may be small particularly because, with respect to occurrence of dents in the inorganic protective layer, the layers having the smallest film elastic modulus among these layers is affected when the carrier is pushed in 2000 nm from the inorganic protective layer side.

The electrophotographic photoreceptor of the present exemplary embodiment will now be described in detail by referring to the drawings. In the drawings, the same or corresponding parts are represented by the same reference signs, and redundant descriptions are avoided.

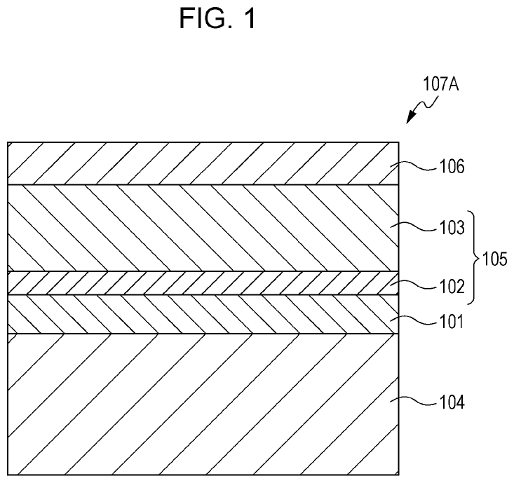

FIG. 1 is a schematic cross-sectional view of one example of the layer structure of an electrophotographic photoreceptor of an exemplary embodiment. A photoreceptor 107A has a structure in which an undercoat layer 101 is formed on a conductive substrate 104, and in which a charge generating layer 102, a charge transporting layer 103, and an inorganic protective layer 106 are sequentially formed on the undercoat layer 101. The photoreceptor 107A includes a function-separated organic photosensitive layer 105 constituted by the charge generating layer 102 and the charge transporting layer 103.

An intermediate layer may be disposed between the conductive substrate 104 and the undercoat layer 101.

In the first exemplary embodiment, the undercoat layer 101, the charge transporting layer 103, and the inorganic protective layer 106 each have a film elastic modulus of 50 GPa or more.

In the second exemplary embodiment, the undercoat layer 101 and the inorganic protective layer 106 are each formed of a metal oxide layer, and the charge transporting layer 103 contains a binder resin, a charge transporting material, and silica particles.

The respective elements constituting the electrophotographic photoreceptor will now be described. In the description below, the reference signs may be omitted.

### Conductive Substrate

Examples of the conductive substrate include metal plates, metal drums, and metal belts that contain metals (aluminum, copper, zinc, chromium, nickel, molybdenum, vanadium, indium, gold, platinum, etc.) or alloys (stainless steel etc.). Other examples of the conductive substrate include paper sheets, resin films, and belts coated, vapor-deposited, or laminated with conductive compounds (for example, conductive polymers and indium oxide), metals (for example, aluminum, palladium, and gold), or alloys. Here, “conductive” means having a volume resistivity of less than 10¹³ Ωcm.

The surface of the conductive substrate may be roughened to a center-line average roughness Ra of 0.04 μm or more and 0.5 μm or less in order to suppress interference fringes that occur when the electrophotographic photoreceptor used in a laser printer is irradiated with a laser beam. When incoherent light is used as a light source, there is no need to roughen the surface to prevent interference fringes, but roughening the surface suppresses generation of defects due to irregularities on the surface of the conductive substrate and thus is desirable for extending the lifetime.

Examples of the surface roughening method include a wet honing method with which an abrasive suspended in water is sprayed onto a conductive support, a centerless grinding with which a conductive substrate is pressed against a rotating grinding stone to perform continuous grinding, and an anodization treatment.

Another example of the surface roughening method does not involve roughening the surface of a conductive substrate but involves dispersing a conductive or semi-conductive powder in a resin and forming a layer of the resin on a surface of a conductive substrate so as to create a rough surface by the particles dispersed in the layer.

The surface roughening treatment by anodization involves forming an oxide film on the surface of a conductive substrate by anodization by using a metal (for example, aluminum) conductive substrate as the anode in an electrolyte solution. Examples of the electrolyte solution include a sulfuric acid solution and an oxalic acid solution. However, a porous anodization film formed by anodization is chemically active as is, is prone to contamination, and has resistivity that significantly varies depending on the environment. Thus, a pore-sealing treatment may be performed on the porous anodization film so as to seal fine pores in the oxide film by volume expansion caused by hydrating reaction in pressurized steam or boiling water (a metal salt such as a nickel salt may be added) so that the oxide is converted into a more stable hydrous oxide.

The thickness of the anodization film may be, for example, 0.3 μm or more and 15 μm or less. When the thickness is within this range, a barrier property against injection tends to be exhibited, and the increase in residual potential caused by repeated use tends to be suppressed.

The conductive substrate may be subjected to a treatment with an acidic treatment solution or a Boehmite treatment.

The treatment with an acidic treatment solution is, for example, conducted as follows. First, an acidic treatment solution containing phosphoric acid, chromic acid, and hydrofluoric acid is prepared. The blend ratios of phosphoric acid, chromic acid, and hydrofluoric acid in the acidic treatment solution may be, for example, in the range of 10 mass % or more and 11 mass % or less for phosphoric acid, in the range of 3 mass % or more and 5 mass % or less for chromic acid, and in the range of 0.5 mass % or more and 2 mass % or less for hydrofluoric acid; and the total concentration of these acids may be in the range of 13.5 mass % or more and 18 mass % or less. The treatment temperature may be, for example, 42° C. or higher and 48° C. or lower. The thickness of the film may be 0.3 μm or more and 15 μm or less.

The Boehmite treatment is conducted by immersing a conductive substrate in pure water at 90° C. or higher and 100° C. or lower for 5 to 60 minutes or by bringing a conductive substrate into contact with pressurized steam at 90° C. or higher and 120° C. or lower for 5 to 60 minutes. The thickness of the film may be 0.1 μm or more and 5 μm or less. The Boehmite-treated body may be further anodized by using an electrolyte solution, such as adipic acid, boric acid, a borate salt, a phosphate salt, a phthalate salt, a maleate salt, a benzoate salt, a tartrate salt, or a citrate salt, that has low film-dissolving power.

In order for the photoreceptor to obtain strength and in order to suppress occurrence of scratches on the inorganic protective layer, the thickness (wall thickness) of the conductive substrate may be 1 mm or more, may be 1.2 mm or more, or may be 1.5 mm or more. Although the upper limit of the thickness of the conductive substrate is not particularly limited, for example, from the viewpoints of suppressing occurrence of scratches on the inorganic protective layer and maneuverability and manufacturability of the photoreceptor, the thickness may be 3.5 mm or less, may be 3 mm or less, or may be less than 3 mm. When the thickness of the conductive substrate is within the aforementioned range, deflection of the conductive substrate is easily suppressed and occurrence of scratches on the inorganic protective layer is easily suppressed.

### Undercoat Layer of First Exemplary Embodiment

The undercoat layer of the first exemplary embodiment has a film elastic modulus of 5 GPa or more.

Any known undercoat layer that is disposed between a conductive substrate and an organic photosensitive layer in an electrophotographic photoreceptor and that can achieve this film elastic modulus can be used as the undercoat layer of the first exemplary embodiment.

Examples of the known undercoat layer include a layer containing a binder resin and a charge transporting material, a layer containing a binder resin and inorganic particles (for example, metal oxide particles), a layer containing a binder resin and resin particles, a layer formed of a cured film (crosslinked film), and a layer formed of a cured film containing various particles.

For example, even when the undercoat layer is a layer containing inorganic particles and a binder resin, such an undercoat layer can be used as the undercoat layer of the first exemplary embodiment as long as the film elastic modulus is adjusted to 5 GPa or more by controlling the material for the inorganic particles, the inorganic particle content, the size of the inorganic particles, etc.

The undercoat layer of the first exemplary embodiment may be a metal oxide layer since a film elastic modulus of 5 GPa or more (or 15 GPa or more) is easily achieved and the mechanical strength, translucency, and conductivity are excellent.

The metal oxide layer is the same as the undercoat layer of the second exemplary embodiment described below, and favorable examples are also the same; thus, the description therefor is omitted here.

### Undercoat Layer of Second Exemplary Embodiment

The undercoat layer of the second exemplary embodiment is formed of a metal oxide layer.

Here, the undercoat layer formed of a metal oxide layer refers to a layer-shaped article composed of a metal oxide (for example, a CVD film of a metal oxide, a vapor-deposited film of a metal oxide, or a sputter-deposited film of a metal oxide), and does not include an agglomerate or an aggregate of metal oxide particles.

The undercoat layer formed of a metal oxide layer may be a metal oxide layer composed of a metal oxide containing a group 13 element and oxygen since mechanical strength, translucency, and electrical conductivity are excellent.

Examples of the metal oxide containing a group 13 element and oxygen include metal oxides such as gallium oxide, aluminum oxide, indium oxide, and boron oxide, and mixed crystals thereof.

Among these, gallium oxide may be used as the metal oxide containing a group 13 element and oxygen since gallium oxide has excellent mechanical strength and translucency, n-type conductivity, and excellent conduction controllability.

In other words, the undercoat layer of the second exemplary embodiment may be formed of a metal oxide layer containing gallium and oxygen.

The undercoat layer formed of a metal oxide layer may be a layer formed of a metal oxide containing a group 13 element (in particular, gallium) and oxygen, but may contain hydrogen and carbon atoms, if needed.

The undercoat layer formed of a metal oxide layer may be a layer that further contains zinc (Zn).

The undercoat layer formed of a metal oxide layer may contain other elements to control the conductivity type. The undercoat layer formed of a metal oxide layer may contain at least one element selected from C, Si, Ge, and Sn in order to control the conductivity type to n-conductivity type, and may contain at least one element selected from N, Be, Mg, Ca, and Sr in order to control the conductivity type to p-conductivity type.

In particular, the undercoat layer formed of a metal oxide layer may contain a group 13 element, oxygen, and hydrogen, and the sum of the element compositional percentages of the group 13 element, oxygen, and hydrogen relative to all elements constituting the undercoat layer formed of a metal oxide layer may be 90 atom % or more.

In the undercoat layer formed of a metal oxide layer, the film elastic modulus can be easily controlled by changing the element compositional ratio of oxygen to the group 13 element (oxygen/group 13 element=O/Ga). In the element compositional ratio of oxygen to the group 13 element (oxygen/group 13 element), the increase in the oxygen compositional ratio tends to increase the film elastic modulus, and the ratio maybe, for example, 1.0 or more and 1.6 or less.

Here, identifying the elements in the undercoat layer formed of a metal oxide layer and measurement of the element constitutional ratio, etc., are done by the same methods described in relation to the inorganic protective layer below, and thus, the description therefor is omitted here.

### Film Elastic Modulus of Undercoat Layer

The film elastic modulus of the undercoat layer formed of a metal oxide layer may be 5 GPa or more or 40 GPa or more. For example, from the viewpoint of the film physical properties of gallium oxide itself, the film elastic modulus may be 65 GPa or more or may particularly be 80 GPa or more. The upper limit of the film elastic modulus of the undercoat layer formed of a metal oxide layer is, for example, 120 GPa or less.

### Volume Resistivity of Undercoat Layer

The volume resistivity of the undercoat layer formed of a metal oxide layer may be 1×10⁶ or more and 1×10¹² or less, or may be 1×10⁷ or more and 1×10⁹ or less.

When the undercoat layer has the aforementioned volume resistivity, the increase in residual potential associated with use is suppressed, and image density abnormality associated with the increase in residual potential is easily suppressed.

The volume resistivity of the undercoat layer is measured by the same method as the method for measuring the volume resistivity of the inorganic protective layer described below.

### Formation of Undercoat Layer Formed of Metal Oxide Layer

The undercoat layer formed of a metal oxide layer is formed by, for example, a gas-phase film forming method such as a plasma chemical vapor deposition (CVD) method, an organic metal gas-phase growth method, a molecular beam epitaxy method, a vapor deposition method, or a sputtering method.

Since a specific method for forming the undercoat layer formed of a metal oxide layer is the same as the method for forming the inorganic protective layer described below, the description therefor is omitted here.

### Thickness of Undercoat Layer

The thickness of the undercoat layer formed of a metal oxide layer may be 0.1 μm or more and 10 μm or less, 0.2 μm or more and 8.0 μm or less, or 0.5 μm or more and 5.0 μm or less.

### Intermediate Layer

Although not illustrated in the drawings, an intermediate layer may be further provided between the undercoat layer and the organic photosensitive layer (in other words, the charge generating layer).

The intermediate layer is, for example, a layer that contains a resin. Examples of the resin used in the intermediate layer include polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may contain an organic metal compound. Examples of the organic metal compound used in the intermediate layer include organic metal compounds containing metal atoms such as zirconium, titanium, aluminum, manganese, and silicon.

These compound used in the intermediate layer may be used alone, or two or more compounds may be used as a mixture or a polycondensation product.

In particular, the intermediate layer may be a layer that contains an organic metal compound that contains zirconium atoms or silicon atoms.

The intermediate layer may be formed by any known method. For example, a coating film is formed by using an intermediate-layer-forming solution prepared by adding the above-mentioned components to a solvent, dried, and, if needed, heated.

Examples of the application method for forming the intermediate layer include common methods such as a dip coating method, a lift coating method, a wire bar coating method, a spray coating method, a blade coating method, a knife coating method, and a curtain coating method.

The thickness of the intermediate layer may be set within the range of, for example, 0.1 μm or more and 3 μm or less. The intermediate layer may be used as the undercoat layer.

### Charge Generating Layer

The charge generating layer is, for example, a layer that contains a charge generating material and a binder resin.

The charge generating layer may be a vapor deposited layer of a charge generating material. The vapor deposited layer of the charge generating material may be used when an incoherent light such as a light emitting diode (LED) or an organic electro-luminescence (EL) image array is used.

Examples of the charge generating material include azo pigments such as bisazo and trisazo pigments; fused-ring aromatic pigments such as dibromoanthanthrone; perylene pigments; pyrrolopyrrole pigments; phthalocyanine pigments; zinc oxide; and trigonal selenium.

Among these, in order to be compatible to the near-infrared laser exposure, a metal phthalocyanine pigment or a metal-free phthalocyanine pigment may be used as the charge generating material. Specific examples thereof include hydroxygallium phthalocyanine disclosed in Japanese Unexamined Patent Application Publication Nos. 5-263007 and 5-279591; chlorogallium phthalocyanine disclosed in Japanese Unexamined Patent Application Publication No. 5-98181; dichlorotin phthalocyanine disclosed in Japanese Unexamined Patent Application Publication Nos. 5-140472 and 5-140473; and titanyl phthalocyanine disclosed in Japanese Unexamined Patent Application Publication No. 4-189873.

In order to be compatible to the near ultraviolet laser exposure, the charge generating material may be a fused-ring aromatic pigment such as dibromoanthanthrone, a thioindigo pigment, a porphyrazine compound, zinc oxide, trigonal selenium, a bisazo pigment disclosed in Japanese Unexamined Patent Application Publication Nos. 2004-78147 and 2005-181992, or the like.

When an incoherent light source, such as an LED or an organic EL image array having an emission center wavelength in the range of 450 nm or more and 780 nm or less, is used, the charge generating material described above may be used; however, from the viewpoint of the resolution, when the organic photosensitive layer is as thin as 20 μm or less, the electric field intensity in the organic photosensitive layer is increased, charges injected from the substrate are decreased, and image defects known as black spots tend to occur. This is particularly noticeable when a charge generating material, such as trigonal selenium or a phthalocyanine pigment, that is of a p-conductivity type and easily generates dark current is used.

In contrast, when an n-type semiconductor, such as a fused-ring aromatic pigment, a perylene pigment, or an azo pigment, is used as the charge generating material, dark current rarely occurs and, even when the thickness is small, image defects known as black spots can be suppressed. Examples of the n-type charge generating material include, but are not limited to, compounds (CG-1) to (CG-27) described in Japanese Unexamined Patent Application Publication No. 2012-155282, paragraphs [0288] to [0291].

Whether n-type or not is determined by a time-of-flight method commonly employed and by the polarity of the photocurrent flowing therein. A material in which electrons flow more smoothly as carriers than holes is determined to be of an n-type.

The binder resin used in the charge generating layer is selected from a wide range of insulating resins. Alternatively, the binder resin may be selected from organic photoconductive polymers, such as poly-N-vinylcarbazole, polyvinyl anthracene, polyvinyl pyrene, and polysilane.

Examples of the binder resin include, polyvinyl butyral resins, polyarylate resins (polycondensates of bisphenols and aromatic dicarboxylic acids etc.), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinyl pyrrolidone resins. Here, “insulating” means having a volume resistivity of 10¹³ Ωcm or more.

These binder resins are used alone or in combination as a mixture.

The blend ratio of the charge generating material to the binder resin may be in the range of 10:1 to 1:10 on a mass ratio basis.

The charge generating layer may contain other known additives.

The charge generating layer may be formed by any known method. For example, a coating film is formed by using a charge-generating-layer-forming solution prepared by adding the above-mentioned components to a solvent, dried, and, if needed, heated. The charge generating layer may be formed by vapor-depositing a charge generating material. The charge generating layer may be formed by vapor deposition particularly when a fused-ring aromatic pigment or a perylene pigment is used as the charge generating material.

Specific examples of the solvent for preparing the charge-generating-layer-forming solution include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in combination as a mixture.

The method for dispersing particles (for example, the charge generating material) in the charge-generating-layer-forming solution can use a media disperser such as a ball mill, a vibrating ball mill, an attritor, a sand mill, or a horizontal sand mill, or a media-less disperser such as stirrer, an ultrasonic disperser, a roll mill, or a high-pressure homogenizer. Examples of the high-pressure homogenizer include a collision-type homogenizer in which the dispersion in a high-pressure state is dispersed through liquid-liquid collision or liquid-wall collision, and a penetration-type homogenizer in which the fluid in a high-pressure state is caused to penetrate through fine channels.

In dispersing, it is effective to set the average particle diameter of the charge generating material in the charge-generating-layer-forming solution to 0.5 μm or less, 0.3 μm or less, or 0.15 μm or less.

Examples of the method for applying the charge-generating-layer-forming solution to the undercoat layer (or the intermediate layer) include common methods such as a blade coating method, a wire bar coating method, a spray coating method, a dip coating method, a bead coating method, an air knife coating method, and a curtain coating method.

The thickness of the charge generating layer may be set within the range of, for example, 0.1 μm or more and 5.0 μm or less, or with in the range of 0.2 μm or more and 2.0 μm or less.

### Charge Transporting Layer of First Exemplary Embodiment

The charge transporting layer of the first exemplary embodiment has a film elastic modulus of 5 GPa or more.

The charge transporting layer of the first exemplary embodiment may be any layer that has a charge transporting ability and can achieve this film elastic modulus.

The charge transporting layer of the first exemplary embodiment may be a layer containing a charge transporting material, a binder resin, and silica particles since such a layer can easily achieve a film elastic modulus of 5 GPa or more and has an excellent charge transporting ability.

The layer containing a charge transporting material, a binder resin, and silica particles is the same as the charge transporting layer of the second exemplary embodiment described below, and examples thereof are also the same. Thus, description is omitted here.

### Charge Transporting Layer of Second Exemplary Embodiment

The charge transporting layer contains a charge transporting material, a binder resin, and silica particles. The charge transporting layer may be a layer that contains a polymer charge transporting material.

Examples of the charge transporting material include electron transporting compounds such as quinone compounds such as p-benzoquinone, chloranil, bromanil, and anthraquinone; tetracyanoquinodimethane compounds; fluorenone compounds such as 2,4,7-trinitrofluorenone; xanthone compounds; benzophenone compounds; cyanovinyl compounds; and ethylene compounds. Other examples of the charge transporting material include hole transporting compounds such as triarylamine compounds, benzidine compounds, aryl alkane compounds, aryl-substituted ethylene compounds, stilbene compounds, anthracene compounds, and hydrazone compounds. These charge transporting materials may be used alone or in combination, but are not limiting.

From the viewpoint of charge mobility, the charge transporting material may be a triaryl amine derivative represented by structural formula (a-1) below or a benzidine derivative represented by structural formula (a-2) below.

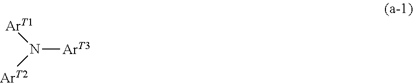

In structural formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C (R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent for each of the groups described above include a halogen atom, an alkyl group having 1 to 5 carbon atoms, and an alkoxy group having 1 to 5 carbon atoms. Examples of the substituent for each of the groups described above include a substituted amino group substituted with an alkyl group having 1 to 3 carbon atoms.

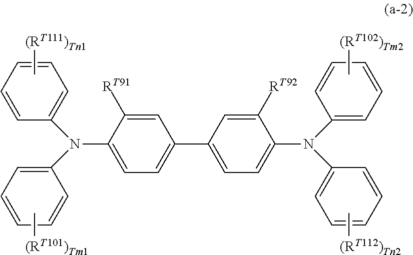

In structural formula (a-2), R^{T91} and R^{T92} each independently represent a hydrogen atom, a halogen atom, an alkyl group having 1 to 5 carbon atoms, or an alkoxy group having 1 to 5 carbon atoms. R^{T101}, R^{T102}, R^{T111}, and R^{T112} each independently represent a halogen atom, an alkyl group having 1 to 5 carbon atoms, an alkoxy group having 1 to 5 carbon atoms, an amino group substituted with an alkyl group having 1 or 2 carbon atoms, a substituted or unsubstituted aryl group, —C(R^{T12})═C(R^{T13})(R^{T14}), or —CH═CH—CH═C(R^{T15})(R^{T16}); and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent for each of the groups described above include a halogen atom, an alkyl group having 1 to 5 carbon atoms, and an alkoxy group having 1 to 5 carbon atoms. Examples of the substituent for each of the groups described above include a substituted amino group substituted with an alkyl group having 1 to 3 carbon atoms.

Here, among the triarylamine derivatives represented by structural formula (a-1) and the benzidine derivatives represented by structural formula (a-2) above, a triarylamine derivative having —C₆H₄—CH═CH—CH═C(R^{T7})(R^{T8}) or a benzidine derivative having —CH═CH—CH═C(R^{T15})(R^{T16}) may be used from the viewpoint of the charge mobility.

Examples of the polymer charge transporting material that can be used include known charge transporting materials such as poly-N-vinylcarbazole and polysilane. In particular, polyester polymer charge transporting materials disclosed in Japanese Unexamined Patent Application Publication Nos. 8-176293 and 8-208820 may be used. The polymer charge transporting material may be used alone or in combination with a binder resin.

The charge transporting layer of the second exemplary embodiment contains silica particles. When the charge transporting layer contains silica particles, the silica particles function as a reinforcing material for the charge transporting layer, and the film elastic modulus easily becomes 5 GPa or more.

From the viewpoint of suppressing occurrence of dents in the inorganic protective layer, the silica particle content relative to the entire charge transporting layer containing the silica particles may be 30 mass % or more and 70 mass % or less. From the same viewpoint, the lower limit of the silica particle content may be 45 mass % or more, or 50 mass % or more. The upper limit of the silica particle content may be 75 mass % or less or 70 mass % or less from the viewpoint of, for example, dispersibility of the silica particles.

The amount of the silica particles contained in the charge transporting layer may be, for example, 30 mass % or more and 70 mass % or less, or may be 50 mass % or more and 70 mass % or less relative to the charge transporting layer.

Examples of the silica particles include dry silica particles and wet silica particles.

Examples of the dry silica particles include pyrogenic silica (fumed silica) prepared by burning a silane compound, and deflagration silica particles prepared by deflagration of metal silicon powder.

Examples of the wet silica particles include wet silica particles obtained by neutralization reaction of sodium silicate and a mineral acid (precipitated silica synthesized and aggregated under alkaline conditions and gel silica particles synthesized and aggregated under acidic conditions), colloidal silica particles obtained by alkalifying and polymerizing acidic silicate (silica sol particles), and sol-gel silica particles obtained by hydrolysis of an organic silane compound (for example, alkoxysilane).

Among these, pyrogenic silica particles having fewer silanol groups on the surface and a low gap structure may be used as the silica particles from the viewpoints of generation of residual potential and suppression of image defects caused by degradation of other electrical properties (suppression of degradation of fine line reproducibility).

The volume-average particle diameter of the silica particles may be, for example, 20 nm or more and 200 nm or less. The lower limit of the volume-average particle diameter of the silica particles may be 40 nm or more or 50 nm or more. The upper limit of the volume-average particle diameter of the silica particles may be 150 nm or less, 120 nm or less, or 110 nm or less.

The volume-average particle diameter of the silica particles is measured by separating the silica particles from the layer, observing 100 primary particles of these silica particles with a scanning electron microscope (SEM) at a magnification of 40000, measuring the longest axis and the shortest axis of each particle by image analysis of the primary particles, and measuring the sphere-equivalent diameter from the intermediate values. The 50% diameter (D50v) in the accumulative frequency of the obtained sphere-equivalent diameters is determined, and assumed to be the volume-average particle diameter of the silica particles.

The silica particles may be surface-treated with a hydrophobizing agent. As a result, the number of silanol groups on the surfaces of the silica particles is decreased, and occurrence of residual potential is smoothly suppressed.

Examples of the hydrophobizing agent include known silane compounds such as chlorosilane, alkoxysilane, and silazane.

Among these, a silane compound having a trimethylsilyl group, a decylsilyl group, or a phenylsilyl group may be used as the hydrophobizing agent from a viewpoint of smoothly suppressing occurrence of residual potential. In other words, trimethylsilyl groups, decylsilyl groups or phenylsilyl groups may be present on the surfaces of the silica particles.

Examples of the silane compound having trimethylsilyl groups include trimethylchlorosilane, trimethylmethoxysilane, and 1,1,1,3,3,3-hexamethyldisilazane.

Examples of the silane compound having decylsilyl groups include decyltrichlorosilane, decyldimethylchlorosilane, and decyltrimethoxysilane.

Examples of the silane compound having phenylsilyl groups include triphenylmethoxysilane and triphenylchlorosilane.

The condensation ratio of hydrophobized silica particles (the ratio of Si—O—Si in the SiO₄— bonds in the silica particles, hereinafter this ratio may be referred to as “condensation ratio of the hydrophobizing agent”) may be, for example, 90% or more, 91% or more, or 95% or more relative to the silanol groups on the surfaces of the silica particles.

When the condensation ratio of the hydrophobizing agent is within the above-described range, the number of silanol groups on the surfaces of the silica particles is decreased, and occurrence of residual potential is smoothly suppressed.

The condensation ratio of the hydrophobizing agent indicates the ratio of condensed silicon relative to all bondable sites of silicon in the condensed portions detected with NMR, and is measured as follows.

First, silica particles are separated from the layer. Separated silica particles are subjected to Si CP/MAS NMR analysis with AVANCE III 400 produced by Bruker, and the peak areas corresponding to the number of SiO substituents are determined. The values for the disubstituted (Si(OH)₂(O—Si)₂—), trisubstituted (Si(OH)(O—Si)₃—), and tetrasubstituted (Si(O—Si)₄—) are respectively assumed to be Q2, Q3, and Q4, and the condensation ratio of the hydrophobizing agent is calculated from the formula: (Q2×2+Q3×3+Q4×4)/4×(Q2+Q3+Q4).

The volume resistivity of the silica particles may be, for example, 10¹¹ Ω·cm or more, 10¹² Ω·cm or more, or 10¹³ Ω·cm or more.

When the volume resistivity of the silica particles is within the above-described range, degradation of the electrical properties is suppressed.

The volume resistivity of the silica particles is measured as follows. The measurement environment involves a temperature of 20° C. and a humidity of 50% RH.

First, silica particles are separated from the layer. Then, the object to be measured, namely, the separated silica particles, is placed on a surface of a circular jig equipped with a 20 cm² electrode plate so that the silica particles form a silica particle layer having a thickness of about 1 mm or more and 3 mm or less. Another identical 20 cm² electrode plate is placed on the silica particle layer so as to sandwich the silica particle layer. In order to eliminate gaps between the silica particles, a load of 4 kg is applied onto the electrode plate on the silica particle layer, and then the thickness (cm) of the silica particle layer is measured. The electrodes above and under the silica particle layer are connected to an electrometer and a high-voltage power generator. A high voltage is applied to the two electrodes so that the electric field reaches a preset value, and the current value (A) that flows at this time is read so as to calculate the volume resistivity (Ωcm) of the silica particles. The calculation formula of the volume resistivity (Ωcm) of the silica particles is as follows.

Note that in the formula, p represents the volume resistivity (Ωcm) of the silica particles, E represents the applied voltage (V), I represents the current value (A), I₀ represents a current value (A) at an applied voltage of 0 V, and L represents the thickness (cm) of the silica particle layer. For evaluation, the volume resistivity at an applied voltage of 1000 V is used.

ρ=E×20/(I−I₀)/L Formula:

Examples of the binder resin used in the charge transporting layer include polycarbonate resins (homopolymers such as bisphenol A, bisphenol Z, bisphenol C, and bisphenol TP, and copolymers thereof), polyarylate resins, polyester resins, methacrylic resins, acrylic resins, polyvinyl chloride resins, polyvinylidene chloride resins, polystyrene resins, acrylonitrile-styrene copolymers, acrylonitrile-butadiene copolymers, polyvinyl acetate resins, styrene-butadiene copolymers, vinyl chloride-vinyl acetate copolymers, vinyl chloride-vinyl acetate-maleic anhydride copolymers, silicone resins, silicone-alkyd resins, phenol-formaldehyde resins, styrene-acryl copolymers, styrene-alkyd resins, poly-N-vinylcarbazole resins, polyvinyl butyral resins, and polyphenylene ether resins. These binder resins are used alone or in combination.

The blend ratio of the charge transporting material to the binder resin may be in the range of 10:1 to 1:5 on a mass ratio basis.

Of the binder resins described above, a polycarbonate resin (a homopolymer of a bisphenol A, bisphenol Z, bisphenol C, or bisphenol TP or a copolymer thereof) may be used. The polycarbonate resins may be used alone or in combination. From the same viewpoint, a homopolymer-type polycarbonate resin of bisphenol Z may be contained among the polycarbonate resins.

From the viewpoint of suppressing occurrence of dents in the inorganic protective layer, the binder resin may have a viscosity-average molecular weight of 50000 or less. The viscosity-average molecular weight may be 45000 or less or 35000 or less.

The lower limit of the viscosity-average molecular weight may be 20000 or more to retain the properties as the binder resin.

The following one-point measurement method is used to measure the viscosity-average molecular weight of the binder resin.

First, from a photoreceptor to be measured, the inorganic protective layer is removed to expose the charge transporting layer to be measured. Then a portion of the charge transporting layer is machined to obtain a measurement sample.

Next, the binder resin is extracted from the measurement sample. In 100 cm³ of methylene chloride, 1 g of the extracted binder resin is dissolved, and the specific viscosity ηsp is measured with a Ubbelohde viscometer in a 25° C. measurement environment. Then the intrinsic viscosity [η] (cm³/g) is determined from the relationship formula: ηsp/c=[η]+0.45 [η]²c, and the viscosity-average molecular weight My is determined from the formula given by H. Schnell, [η]=1.23×10⁻⁴ Mv^{0.83}.

The charge transporting layer may contain other known additives.

The charge transporting layer may be formed by any known method. For example, a coating film is formed by using a charge-transporting-layer-forming solution prepared by adding the above-mentioned components to a solvent, dried, and, if needed, heated.

Examples of the solvent used to prepare the charge-transporting-layer-forming solution include common organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in combination as a mixture.

Examples of the method for applying the charge-transporting-layer-forming solution to the charge generating layer include common methods such as a blade coating method, a wire bar coating method, a spray coating method, a dip coating method, a bead coating method, an air knife coating method, and a curtain coating method.

When particles (for example, silica particles or fluororesin particles) are to be dispersed in the charge-transporting-layer-forming solution, a dispersing method that uses, for example, a media disperser such as a ball mill, a vibrating ball mill, an attritor, a sand mill, or a horizontal sand mill, or a media-less disperser such as stirrer, an ultrasonic disperser, a roll mill, or a high-pressure homogenizer is employed. Examples of the high-pressure homogenizer include a collision-type homogenizer in which the dispersion in a high-pressure state is dispersed through liquid-liquid collision or liquid-wall collision, and a penetration-type homogenizer in which the fluid in a high-pressure state is caused to penetrate through fine channels.

The surface roughness Ra (arithmetic mean surface roughness Ra) of the charge transporting layer measured at a surface on the inorganic protective layer side is, for example, 0.06 μm or less, may be 0.03 μm or less, or may be 0.02 μm or less.

When the surface roughness Ra is within the above-described range, the flatness and smoothness of the inorganic protective layer are enhanced, and the cleaning properties are improved.

In order to adjust the surface roughness Ra to be within the above-described range, for example, the thickness of the layer may be increased.

The surface roughness Ra is measured as follows.

First, after the inorganic protective layer is removed, the layer to be measured is exposed. Then a portion of that layer is cut with a cutter or the like to obtain a measurement sample.

A stylus-type surface roughness meter (SURFCOM 1400A produced by TOKYO SEIMITSU CO., LTD., for example) is used to measure the measurement sample. The measurement conditions are set according to JIS B 0601-1994 with evaluation length Ln=4 mm, reference length L=0.8 mm, and cut-off value=0.8 mm.

The film elastic modulus of the charge transporting layer may be, for example, 5 GPa or more or 6 GPa or more, as described in the first exemplary embodiment.

When the elastic modulus of the charge transporting layer is within the above-described range, occurrence of dents in the inorganic protective layer is smoothly suppressed.

In order to adjust the elastic modulus of the charge transporting layer to be within the above-described range, for example, the particle diameter and the amount of the silica particles may be adjusted, or the type and the amount of the charge transporting material may be adjusted.

The thickness of the charge transporting layer may be, for example, 10 μm or more and 40 μm or less, may be 10 μm or more and 35 μm or less, or may be 15 μm or more and 35 μm or less.

When the thickness of the charge transporting layer is within the above-describe range, occurrence of dents in the inorganic protective layer and occurrence of the residual potential are smoothly suppressed.

### Inorganic Protective Layer of First Exemplary Embodiment

The inorganic protective layer of the first exemplary embodiment has a film elastic modulus of 5 GPa or more.

Any known inorganic protective layer that is used in an electrophotographic photoreceptor and can achieve this film elastic modulus can be used as the inorganic protective layer of the first exemplary embodiment.

The inorganic protective layer of the first exemplary embodiment may be a metal oxide layer since a film elastic modulus of 5 GPa or more is easily achieved and the mechanical strength, translucency, and conductivity are excellent.

The metal oxide layer is the same as the inorganic protective layer of the second exemplary embodiment described below, and favorable examples are also the same; thus, the description therefor is omitted here.

### Inorganic Protective Layer of Second Exemplary Embodiment

The inorganic protective layer of the second exemplary embodiment is formed of a metal oxide layer.

Here, as with the undercoat layer, the inorganic protective layer formed of a metal oxide layer refers to a layer-shaped article composed of a metal oxide (for example, a CVD film of a metal oxide, a vapor-deposited film of a metal oxide, or a sputter-deposited film of a metal oxide), and does not include an agglomerate or an aggregate of metal oxide particles.

### Composition of Inorganic Protective Layer

The inorganic protective layer formed of a metal oxide layer may be a metal oxide layer composed of a metal oxide containing a group 13 element and oxygen since mechanical strength, translucency, and electrical conductivity are excellent.

Examples of the metal oxide containing a group 13 element and oxygen include metal oxides such as gallium oxide, aluminum oxide, indium oxide, and boron oxide, and mixed crystals thereof.

Among these, gallium oxide may be used as the metal oxide containing a group 13 element and oxygen since gallium oxide has excellent mechanical strength and translucency, n-type conductivity, and excellent conduction controllability.

In other words, the inorganic protective layer of the second exemplary embodiment may be formed of a metal oxide layer containing gallium and oxygen.

The inorganic protective layer formed of a metal oxide layer contains, for example, a group 13 element (for example, gallium) and oxygen, and may contain hydrogen and carbon as needed.

When hydrogen is contained in the inorganic protective layer formed of a metal oxide layer, physical properties of the inorganic protective layer formed of a metal oxide layer containing a group 13 element (for example, gallium) and oxygen can be easily controlled. For example, in an inorganic protective layer formed of a metal oxide layer containing gallium, oxygen, and hydrogen (for example, an inorganic protective layer composed of hydrogen-containing gallium oxide), the volume resistivity can be easily controlled within the range of 10⁷ Ω·cm or more and 10¹⁴ 5-cm or less when the compositional ratio [O]/[Ga] is changed from 1.0 to 1.5.

In particular, the inorganic protective layer formed of a metal oxide layer may contain a group 13 element, oxygen, and hydrogen, and the sum of the element constitutional ratios of the group 13 element, oxygen, and hydrogen relative to all elements constituting the inorganic protective layer may be 90 atom % or more.

The film elastic modulus can be easily controlled by changing the oxygen-to-group 13 element compositional ratio ((oxygen/group 13 element). There is a tendency that, for the element compositional ratio (oxygen/group 13 element) of oxygen to the group 13 element, the film elastic modulus increases with the oxygen compositional ratio. The ratio may be, for example, 1.0 or more and less than 1.5, may be 1.03 or more and 1.47 or less, may be 1.05 or more and 1.45 or less, or may be 1.10 or more and 1.40 or less.

When the element compositional ratio (oxygen/group 13 element) of the material constituting the inorganic protective layer formed of a metal oxide layer is within the above-described range, image defects caused by scratches on the surface of the photoreceptor are suppressed, affinity to the fatty acid metal salt supplied to the surface of the photoreceptor is improved, and contamination in the apparatus by the fatty acid metal salt is suppressed. From the same viewpoints, the group 13 element may be gallium.

When the sum of the element constitutional ratios of the group 13 element (especially gallium), oxygen, and hydrogen relative to all elements constituting the inorganic protective layer formed of a metal oxide layer is 90 atom % or more, for example, and when a group 15 element, such as N, P, or As, and the like are mixed in, the effect of mixed-in elements bonding with the group 13 element (especially gallium) is suppressed, and the appropriate range can be easily found for the compositional ratio (oxygen/group 13 element (especially gallium)) of oxygen to the group 13 element (especially gallium), which can improve hardness and electrical properties of the inorganic protective layer. The sum of the element constitutional ratios may be 95 atom % or more, may be 96 atom % or more, or may be 97 atom % or more from the above-described viewpoints.

The inorganic protective layer formed of a metal oxide layer may contain other elements in addition to the group 13 element, oxygen, hydrogen, and carbon to control the conductivity type.

The inorganic protective layer formed of a metal oxide layer may contain at least one element selected from C, Si, Ge, and Sn in order to control the conductivity type to n-conductivity type, and may contain at least one element selected from N, Be, Mg, Ca, and Sr to control the conductivity type to p-conductivity type.

When the inorganic protective layer formed of a metal oxide layer is configured to contain gallium, oxygen, and, if needed, hydrogen, possible element constitutional ratios are as follows from the viewpoint of excellent mechanical strength, translucency, flexibility, and conduction controllability:

The element constitutional ratio for gallium relative to all elements constituting the inorganic protective layer may be, for example, 15 atom % or more and 50 atom % or less, may be 20 atom % or more and 40 atom % or less, or may be 20 atom % or more and 30 atom % or less.

The element constitutional ratio for oxygen relative to all elements constituting the inorganic protective layer may be, for example, 30 atom % or more and 70 atom % or less, may be 40 atom % or more and 60 atom % or less, or may be 45 atom % or more and 55 atom % or less.

The element constitutional ratio for hydrogen relative to all elements constituting the inorganic protective layer may be, for example, 10 atom % or more and 40 atom % or less, may be 15 atom % or more and 35 atom % or less, or may be 20 atom % or more and 30 atom % or less.

Identification of the elements, the element constitutional ratios, ratios of the number of atoms, etc., of the elements in the inorganic protective layer, as well as the distribution in the thickness direction, are determined by Rutherford back-scattering (hereinafter, referred to as “RBS”).

In RBS, 3SDH Pelletron produced by National Electrostatics Corp., is used as an accelerator, RBS-400 produced by CE&A is used as an end station, and 3S-R10 is used as the system. A HYPRA program produced by CE&A or the like is used in the analysis.

Regarding the RBS measurement conditions, He++ ion beam energy is 2.275 eV, detection angle is 160°, and the grazing angle with respect to the incident beam is about 1090.

The specific procedure for RBS measurement is as follows.

First, a He++ ion beam is applied perpendicular to the sample, the detector is set at 160° with respect to the ion beam, and back-scattered He signals are measured. The compositional ratio and the film thickness are determined from the detected He energy and intensity. The spectrum may be measured by using two detection angles to improve the accuracy of determining the compositional ratio and the thickness. The accuracy is improved by measuring at two detection angles of different resolutions in the depth direction or different back-scattering dynamics, and cross-checking the results.

The number of He atoms back-scattered by the target atoms is determined by three factors: 1) the atomic number of the target atoms, 2) the energy of the He atoms before scattering, and 3) the scattering angle.

The density is assumed from the measured composition by calculation, and the assumed value of density is used to calculate the thickness. The error in density is within 20%.

The element constitutional ratio for hydrogen is determined by hydrogen forward scattering (hereinafter, referred to as “HFS”).

In HFS, 3SDH Pelletron produced by National Electrostatics Corp., is used as an accelerator, RBS-400 produced by CE&A is used as an end station, and 3S-R10 is used as the system. A HYPRA program produced by CE&A is used in the analysis. The HFS measurement conditions are as follows.
He++ ion beam energy: 2.275 eV
Detection angle: 160°
Grazing angle with respect to incident beam: 30°

In HFS measurement, the detector is set at 30° with respect to the He++ ion beam, and the sample is set at 750 with respect to the normal line so as to pick up signals from hydrogen scattered forward from the sample. During this process, the detector may be covered with an aluminum foil to remove He atoms that scatter along with the hydrogen atoms. The quantitative determination is carried out by normalizing the hydrogen counts from reference samples and the measurement sample with a stopping power, and then comparing the results. As the reference samples, a sample prepared by ion-implanting H into Si, and white mica are used.

White mica is known to have a hydrogen concentration of 6.5 atom %.

For H atoms adsorbing the outermost surface, for example, correction is implemented by subtracting the amount of H adsorbing a clean Si surface.

The inorganic protective layer formed of a metal oxide layer may have a distribution of compositional ratio in the thickness direction or may have a multilayer structure, depending on the purpose.

### Properties of Inorganic Protective Layer

The surface roughness Ra (arithmetic mean surface roughness Ra) of the outer circumferential surface (in other words, the surface of an electrophotographic photoreceptor 7) of the inorganic protective layer formed of a metal oxide layer is, for example, 5 nm or less, may be 4.5 nm or less, or may be 4 nm or less.

When the surface roughness Ra is within the above-described range, charging non-uniformity is suppressed.

In order to adjust the surface roughness Ra to be within the above-described range, for example, the surface roughness Ra of the charge transporting layer measured at a surface on the inorganic protective layer side may be adjusted to be within the above-described range.

Measurement of the surface roughness Ra of the outer circumferential surface of the inorganic protective layer involves the same method as the measurement of the surface roughness Ra of the charge transporting layer at a surface on the inorganic protective layer side except for that the outer circumferential surface of the inorganic protective layer is directly measured.

The volume resistivity of the inorganic protective layer formed of a metal oxide layer may be 5.0×10⁷ Ωcm or more and less than 1.0×10¹² Ωcm. From the viewpoints of facilitating suppression of occurrence of image deletion and image defects caused by scratches on the surface of the photoreceptor, the volume resistivity of the inorganic protective layer may be 8.0×010 cm or more and 7.0×10¹¹ Ωcm or less, 1.0×10⁸ Ωcm or more and 5.0×10¹¹ Ωcm or less, or 5.0×10⁸ Ωcm or more and 2.0×10¹¹ Ωcm or less.

The volume resistivity is determined by calculation from a resistance value measured with LCR meter ZM2371 produced by NF Corporation at a frequency of 1 kHz and a voltage of 1 V, and from the electrode area and the sample thickness.

The measurement sample may be a sample obtained by forming a film on an aluminum substrate under the same conditions as those for forming the inorganic protective layer to be measured, and forming a gold electrode on the formed film by vacuum vapor deposition. Alternatively, the measurement sample may be a sample prepared by separating the inorganic protective layer from an already made electrophotographic photoreceptor, etching some part of the inorganic surface layer, and interposing the etched layer between a pair of electrodes.

The inorganic protective layer formed of a metal oxide layer may be a non-single-crystal film such as a microcrystalline film, a polycrystal film, or an amorphous film. Among these, an amorphous film may be used for its flatness and smoothness, and a microcrystalline film may be used from the viewpoint of hardness.

The growth section of the inorganic protective layer may have a columnar structure; however, from the viewpoint of slippage, a structure having high flatness may be employed, or an amorphous structure may be employed.

The crystallinity and amorphousness are identified by the absence or presence of dots and lines in a diffraction image obtained by reflection high energy electron diffraction (RHEED) measurement.

The film elastic modulus of the inorganic protective layer formed of a metal oxide layer may be 5 GPa or more, may be 30 GPa or more, or may be 40 GPa or more and 120 GPa or less.

When the elastic modulus is within the above-described range, occurrence of recesses (scratches), separation, and cracking in the inorganic protective layer is easily suppressed.

The thickness of the inorganic protective layer may be, for example, 0.2 μm or more and 10.0 μm or less, may be 1.0 m or more and 10 μm or less, or may be 3.0 μm or more and m or less.

When the thickness is within the above-described range, occurrence of recesses (scratches), separation, and cracking in the inorganic protective layer is smoothly suppressed.

### Formation of Inorganic Protective Layer

The inorganic protective layer is formed by, for example, a known gas-phase film forming method such as a plasma chemical vapor deposition (CVD) method, an organic metal gas-phase growth method, a molecular beam epitaxy method, a vapor deposition method, or a sputtering method.

Formation of the inorganic protective layer will now be described through specific examples with reference to the drawings illustrating an example of the film forming apparatus. Although the description below is directed to a method for forming an inorganic protective layer containing gallium, oxygen, and hydrogen, the method is not limited to this, and any known forming method may be applied depending on the composition of the inorganic protective layer to be obtained.

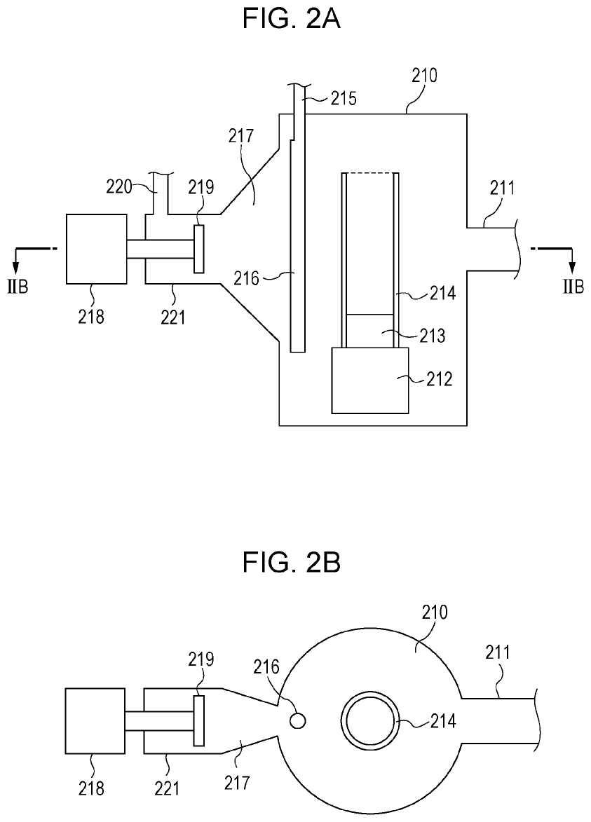

FIGS. 2A and 2B are each a schematic diagram illustrating one example of a film-forming apparatus used to form an inorganic protective layer of the electrophotographic photoreceptor of the present exemplary embodiment. FIG. 2A is a schematic side sectional view of the film forming apparatus, and FIG. 2B is a schematic sectional view of the film forming apparatus illustrated in FIG. 2A taken along line IIB-IIB. In FIGS. 2A and 2B, reference numeral 210 denotes a deposition chamber, 211 denotes an exhaust port, 212 denotes a substrate rotating unit, 213 denotes a substrate supporting member, 214 denotes a substrate, 215 denotes a gas inlet duct, 216 denotes a shower nozzle having an opening through which gas, which is introduced from the gas inlet duct 215, is jet out, 217 denotes a plasma diffusing section, 218 denotes a high-frequency power supply unit, 219 denotes a flat plate electrode, 220 denotes a gas inlet duct, and 221 denotes a high-frequency discharge tube unit.

In the film forming apparatus illustrated in FIGS. 2A and 2B, the exhaust port 211 connected to a vacuum evacuator (not illustrated) is installed on one end of the deposition chamber 210. A plasma generator constituted by the high-frequency power supply unit 218, the flat plate electrode 219, and the high-frequency discharge tube unit 221 is installed on the side opposite to the side where the exhaust port 211 of the deposition chamber 210 is formed.

This plasma generator is constituted by the high-frequency discharge tube unit 221, the flat plate electrode 219 installed inside the high-frequency discharge tube unit 221 and having a discharge surface provided on the exhaust port 211 side, and the high-frequency power supply unit 218 installed outside the high-frequency discharge tube unit 221 and connected to the surface of the flat plate electrode 219 opposite of the discharge surface. The gas inlet duct 220 for supplying gas into the interior of the high-frequency discharge tube unit 221 is connected to the high-frequency discharge tube unit 221, and the other end of the gas inlet duct 220 is connected to a first gas supply source not illustrated in the drawing.

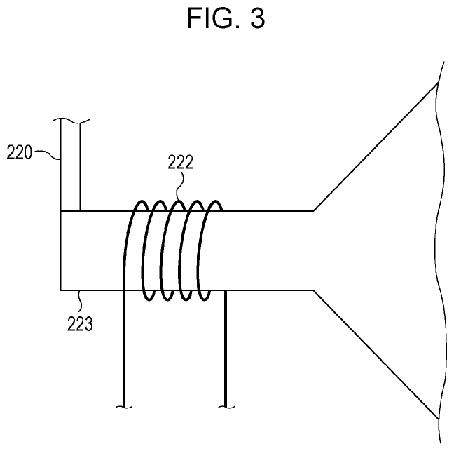

Instead of the plasma generator installed in the film forming apparatus illustrated in FIGS. 2A and 2B, a plasma generator illustrated in FIG. 3 may be used. FIG. 3 is a schematic diagram illustrating another example of the plasma generator used in the film forming apparatus illustrated in FIGS. 2A and 2B, and is a side view of the plasma generator. In FIG. 3, reference numeral 222 denotes a high-frequency coil, 223 denotes a quartz tube, and 220 denotes the same part as that illustrated in FIGS. 2A and 2B. The plasma generator is constituted by the quartz tube 223 and the high-frequency coil 222 installed along the outer circumferential surface of the quartz tube 223. One end of the quartz tube 223 is connected to the deposition chamber 210 (not illustrated in FIG. 3). The other end of the quartz tube 223 is connected to the gas inlet duct 220 through which gas is introduced into the quartz tube 223.

In FIGS. 2A and 2B, a rod-shaped shower nozzle 216 extending along the discharge surface is connected to the discharge surface side of the flat plate electrode 219, one end of the shower nozzle 216 is connected to the gas inlet duct 215, and the gas inlet duct 215 is connected to a second gas supply source (not illustrated in the drawing) disposed outside the deposition chamber 210.

In the deposition chamber 210, the substrate rotating unit 212 is installed. A cylindrical substrate 214 is attachable to the substrate rotating unit 212 via the substrate supporting member 213 so that the longitudinal direction of the shower nozzle 216 and the axis direction of the substrate 214 face each other. In forming the film, the substrate rotating unit 212 is rotated so that the substrate 214 is rotated in the circumferential direction. For example, a multilayer body for producing a photoreceptor, the multilayer body having layers stacked up to the charge transporting layer, is used as the substrate 214.

The inorganic protective layer is formed as follows, for example.

First, oxygen gas (or helium (He)-diluted oxygen gas), helium (He) gas, and, if needed, hydrogen (H₂) gas are introduced into the high-frequency discharge tube unit 221 from the gas inlet duct 220, and 13.56 MHz radio waves are supplied to the flat plate electrode 219 from the high-frequency power supply unit 218. During this process, the plasma diffusing section 217 is formed so as to be radially spread from the discharge surface side of the flat plate electrode 219 toward the exhaust port 211 side. The gas introduced from the gas inlet duct 220 flows in the deposition chamber 210 from the flat plate electrode 219 side toward the exhaust port 211 side. The flat plate electrode 219 may be surrounded by an earth shield.

Next, trimethyl gallium gas is introduced into the deposition chamber 210 through the gas inlet duct 215 and the shower nozzle 216 located downstream of the flat plate electrode 219, which is an activating unit, so as to form a non-single-crystal film that contains gallium, oxygen, and hydrogen on the surface of the substrate 214.

A multilayer body for producing a photoreceptor, the multilayer body having layers stacked up to the charge transporting layer, is used as the substrate 214.

The temperature of the surface of the substrate 214 during formation of the inorganic protective layer may be 150° C. or lower, 100° C. or lower, or 30° C. or higher and 100° C. or lower since there is an organic photosensitive layer that includes a charge generating layer and a charge transporting layer.

Even when the temperature of the surface of the substrate 214 is 150° C. or lower at the time the film formation is started, the temperature may rise to 150° C. or higher due to plasma. In such a case, the organic photosensitive layer may be damaged by heat. Thus, the surface temperature of the substrate 214 may be controlled by considering this possibility.

The temperature of the surface of the substrate 214 may be controlled by using one or both of a heating unit and a cooling unit (not illustrated in the drawing), or may be left to naturally rise during the process of discharging. When the substrate 214 is to be heated, a heater may be installed on the inner or outer side of the substrate 214. When the substrate 214 is to be cooled, a gas or liquid for cooling may be circulated on the inner side of the substrate 214.

In order to avoid elevation of the temperature of the surface of the substrate 214 due to discharging, it is effective to adjust high-energy gas flow applied to the surface of the substrate 214. In such a case, conditions such as the gas flow rate, the discharge output, and the pressure are adjusted so as to achieve the desirable temperature.

In addition, an organic metal compound containing aluminum or a hydride such as diborane can be used instead of trimethylgallium gas, and two or more of such materials may be mixed and used.

For example, in the initial stage of forming the inorganic protective layer, trimethylindium is introduced into the deposition chamber 210 through the gas inlet duct 215 and the shower nozzle 216 so as to form a film containing nitrogen and indium on the substrate 214. This film absorbs ultraviolet light, which is generated when film formation is continued and which deteriorates the organic photosensitive layer. Thus, damage on the organic photosensitive layer due to generation of ultraviolet light during film formation is suppressed.

Regarding the doping method using a dopant during film formation, SiH₃ or SnH₄ in a gas state is used for the n-type, and biscyclopentadienyl magnesium, dimethylcalcium, dimethylstrontium, or the like in a gas state is used for the p-type. In order to dope the surface layer with a dopant element, a known method, such as a thermal diffusion method or an ion implantation method, may be employed.

Specifically, for example, gas containing at least one dopant element is introduced into the deposition chamber 210 through the gas inlet duct 215 and the shower nozzle 216 so as to obtain an inorganic protective layer of an n- or p-conductivity type.

For the film forming apparatus illustrated in FIGS. 2A, 2B, and 3, active nitrogen or active hydrogen formed by discharge energy may be independently controlled by installing multiple activation devices, or gas containing both nitrogen and hydrogen atoms, such as NH₃, may be used. Furthermore, H₂ may be added. The conditions under which active hydrogen are liberated and generated from the organic metal compound may be employed.

In this manner, carbon atoms, gallium atoms, nitrogen atoms, hydrogen atoms, etc., that have been activated exist in a controlled state on the surface of the substrate 214. The activated hydrogen atoms have an effect of causing desorption of hydrogen atoms in the hydrocarbon groups, such as methyl groups and ethyl groups, constituting the organic metal compound, the hydrogen atoms taking a molecular form.

Thus, a hard film (inorganic protective layer) having three-dimensional bonds is formed.

The plasma generators for the film forming apparatus illustrated in FIGS. 2A, 2B, and 3 use a high-frequency oscillator. However, the plasma generator is not limited to this. For example, a microwave oscillator may be used, or an electrocyclotron resonance-type or helicon plasma-type device may be used. The high-frequency oscillator may be of an induction type or of a capacitance type.

Two or more of these devices may be used in combination, or two or more of the same type of devices may be used in combination. In order to suppress temperature elevation of the surface of the substrate 214 due to plasma irradiation, a high-frequency oscillator may be used. Alternatively, a device that suppresses heat irradiation may be provided.

When two or more different types of plasma generators (plasma generating units) are used, discharging may be caused to occur simultaneously at the same pressure. Alternatively, the difference in pressure may be created between a region where discharging occurs and a region where film formation is performed (portion where the substrate is installed). These devices may be arranged in series in the film forming apparatus with respect to the gas flow formed from the portion where the gas is introduced toward the portion where the gas is discharged. Alternatively, all of the devices may be arranged to oppose the film-forming surface of the substrate.

For example, when two types of plasma generators are arranged in series with respect to the gas flow, the film forming apparatus illustrated in FIGS. 2A and 2B is used as a second plasma generator that induces discharging in the deposition chamber 210 by using the shower nozzle 216 as the electrode. In such a case, for example, a high-frequency voltage is applied to the shower nozzle 216 via the gas inlet duct 215 so as to induce discharging in the deposition chamber 210 using the shower nozzle 216 as the electrode. Alternatively, instead of using the shower nozzle 216 as the electrode, a cylindrical electrode may be provided between the substrate 214 and the flat plate electrode 219 in the deposition chamber 210, and discharging may be induced in the deposition chamber 210 by using this cylindrical electrode.

When two different plasma generators are used at the same pressure, for example, when a microwave oscillator and a high-frequency oscillator are used, the excitation energy of the excited species can be significantly changed, and thus this is effective for controlling the quality of the film. Discharging may be performed at a pressure near the atmospheric air pressure (70000 Pa or more and 110000 Pa or less). When discharging is to be performed at a pressure near the atmospheric air pressure, He may be used as the carrier gas.

The inorganic protective layer is formed by, for example, installing the substrate 214, which is a multilayer body for producing a photoreceptor and with layers up to the charge transporting layer stacked therein, in the deposition chamber 210 and introducing mixed gases having different compositions.

Regarding the film forming conditions, for example, when discharging is performed by high-frequency discharging, the frequency may be in the range of 10 kHz or more and 50 MHz or less in order to perform high-quality film formation at low temperature. The output depends on the size of the substrate 214, but the output may be in the range of 0.01 W/cm² or more and 0.2 W/cm² or less relative to the surface area of the substrate. The speed of rotation of the substrate 214 may be in the range of 0.1 rpm or more and 500 rpm or less.

### Image Forming Apparatus and Process Cartridge

An image forming apparatus of an exemplary embodiment includes an electrophotographic photoreceptor, a charging unit that charges a surface of the electrophotographic photoreceptor, an electrostatic latent image forming unit that forms an electrostatic latent image on the charged surface of the electrophotographic photoreceptor, a developing unit that develops the electrostatic latent image on the surface of the electrophotographic photoreceptor by using a developer that contains a toner so as to form a toner image, and a transfer unit that transfers the toner image onto a surface of a recording medium. The electrophotographic photoreceptor of the exemplary embodiment described above is used as the electrophotographic photoreceptor.

The image forming apparatus of the exemplary embodiment is applied to a known image forming apparatus, examples of which include an apparatus equipped with a fixing unit that fixes the toner image transferred onto the surface of the recording medium; a direct transfer type apparatus with which the toner image formed on the surface of the electrophotographic photoreceptor is directly transferred to the recording medium; an intermediate transfer type apparatus with which the toner image formed on the surface of the electrophotographic photoreceptor is first transferred to a surface of an intermediate transfer body and then the toner image on the surface of the intermediate transfer body is transferred to the surface of the recording medium; an apparatus equipped with a cleaning unit that cleans the surface of the electrophotographic photoreceptor after the toner image transfer and before charging; an apparatus equipped with a charge erasing unit that erases the charges on the surface of the electrophotographic photoreceptor by applying the charge erasing light after the toner image transfer and before charging; and an apparatus equipped with an electrophotographic photoreceptor heating member that elevates the temperature of the electrophotographic photoreceptor to reduce the relative temperature.

In the intermediate transfer type apparatus, the transfer unit includes, for example, an intermediate transfer body having a surface onto which a toner image is to be transferred, a first transfer unit that conducts first transfer of the toner image on the surface of the electrophotographic photoreceptor onto the surface of the intermediate transfer body, and a second transfer unit that conducts second transfer of the toner image on the surface of the intermediate transfer body onto a surface of a recording medium.

The image forming apparatus of this exemplary embodiment may be of a dry development type or a wet development type (development type that uses a liquid developer).

In the image forming apparatus of the exemplary embodiment, for example, a section that includes the electrophotographic photoreceptor may be configured as a cartridge structure (process cartridge) detachably attachable to the image forming apparatus. A process cartridge equipped with the electrophotographic photoreceptor of the exemplary embodiment may be used as this process cartridge. The process cartridge may include, in addition to the electrophotographic photoreceptor, at least one selected from the group consisting of a charging unit, an electrostatic latent image forming unit, a developing unit, and a transfer unit.

Although some examples of the image forming apparatus of an exemplary embodiment are described below, these examples are not limiting. Only relevant sections illustrated in the drawings are described, and descriptions of other sections are omitted.

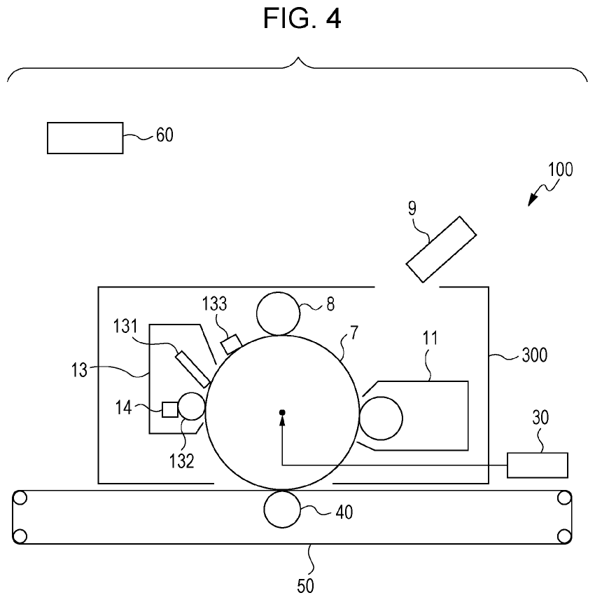

FIG. 4 is a schematic diagram illustrating one example of an image forming apparatus according to the exemplary embodiment.

As illustrated in FIG. 4, an image forming apparatus 100 of this exemplary embodiment includes a process cartridge 300 equipped with an electrophotographic photoreceptor 7, an exposing device 9 (one example of the electrostatic latent image forming unit), a transfer device 40 (first transfer device), and an intermediate transfer body 50. In this image forming apparatus 100, an exposing device 9 is positioned so that light can be applied to the electrophotographic photoreceptor 7 from the opening of the process cartridge 300, the transfer device 40 is positioned to oppose the electrophotographic photoreceptor 7 with the intermediate transfer body 50 therebetween, and the intermediate transfer body 50 has a portion in contact with the electrophotographic photoreceptor 7. Although not shown in the drawings, a second transfer device that transfers the toner image on the intermediate transfer body 50 onto a recording medium (for example, a paper sheet) is also provided. The intermediate transfer body 50, the transfer device 40 (first transfer device), and the second transfer device (not illustrated) correspond to examples of the transfer unit. In the image forming apparatus 100, a control device 60 (one example of the control unit) controls the operation of the respective devices and members in the image forming apparatus 100, and is connected to the devices and the members.

The process cartridge 300 illustrated in FIG. 4 integrates and supports the electrophotographic photoreceptor 7, a charging device 8 (one example of the charging unit), a developing device 11 (one example of the developing unit), and a cleaning device 13 (one example of the cleaning unit) in the housing. The cleaning device 13 has a cleaning blade (one example of the cleaning member) 131, and the cleaning blade 131 is in contact with the surface of the electrophotographic photoreceptor 7. The cleaning member may take a form other than the cleaning blade 131, and may be a conductive or insulating fibrous member that can be used alone or in combination with the cleaning blade 131.

Although an example of the image forming apparatus equipped with a fibrous member 132 (roll) that supplies a lubricant 14 to the surface of the electrophotographic photoreceptor 7 and a fibrous member 133 (flat brush) that assists cleaning is illustrated in FIG. 4, these members are optional.

The features of the image forming apparatus of this exemplary embodiment will now be described.

### Charging Device

Examples of the charging device 8 include contact-type chargers that use conductive or semi-conducting charging rollers, charging brushes, charging films, charging rubber blades, and charging tubes. Known chargers such as non-contact-type roller chargers, and scorotron chargers and corotron chargers that utilize corona discharge are also be used.

### Exposing Device

Examples of the exposing device 9 include optical devices that can apply light, such as semiconductor laser light, LED light, or liquid crystal shutter light, into an image shape onto the surface of the electrophotographic photoreceptor 7. The wavelength of the light source is to be within the spectral sensitivity range. The mainstream wavelength of the semiconductor lasers is near infrared having an oscillation wavelength at about 780 nm. However, the wavelength is not limited to this, and a laser having an oscillation wavelength on the order of 600 nm or a blue laser having an oscillation wavelength of 400 nm or more and 450 nm or less may be used. In order to form a color image, a surface-emitting laser light source that can output multi beams is also effective.

### Developing Device

Examples of the developing device 11 include common developing devices that perform development by using a developer in contact or non-contact manner. The developing device 11 is not particularly limited as long as the aforementioned functions are exhibited, and is selected according to the purpose. An example thereof is a known developer that has a function of attaching a one-component developer or a two-component developer to the electrophotographic photoreceptor 7 by using a brush, a roller, or the like. In particular, a development roller that retains the developer on its surface may be used.

The developer used in the developing device 11 may be a one-component developer that contains only a toner or a two-component developer that contains a toner and a carrier. The developer may be magnetic or non-magnetic. Any known developers may be used as these developers.

### Cleaning Device

A cleaning blade type device equipped with a cleaning blade 131 is used as the cleaning device 13.

Instead of the cleaning blade type, a fur brush cleaning type device or a development-cleaning simultaneous type device may be employed.

### Transfer Device

Examples of the transfer device 40 include contact-type transfer chargers that use belts, rollers, films, rubber blades, etc., and known transfer chargers such as scorotron transfer chargers and corotron transfer chargers that utilize corona discharge.

### Intermediate Transfer Body

A belt-shaped member (intermediate transfer belt) that contains semi-conducting polyimide, polyamide imide, polycarbonate, polyarylate, a polyester, a rubber or the like is used as the intermediate transfer body 50. The form of the intermediate transfer body other than the belt may be a drum.

### Control Device

The control device 60 is configured as a computer that performs control and various computing for the entire apparatus. Specifically, the control device 60 is equipped with a central processing unit (CPU), a read only memory (ROM) storing various programs, a random access memory (RAM) used as the work area during execution of the program, a non-volatile memory storing various information, and an input/output interface (I/O). The CPU, the ROM, the RAM, the non-volatile memory, and the I/O are connected through a bus. Various devices of the image forming apparatus 100, such as the electrophotographic photoreceptor 7 (including a drive motor 30), the charging device 8, the exposing device 9, the developing device 11, and the transfer device 40, are connected to the I/O.

The CPU, for example, runs the program stored in the ROM or the non-volatile memory (for example, a control program such as an image forming sequence or recovering sequence), and controls the operation of the respective devices of the image forming apparatus 100. The RAM is used as a work memory. Programs executed by the CPU and data necessary for processing in the CPU are stored in the ROM and the non-volatile memory. The control programs and various data may be stored in other storing devices, such as a storage unit, or may be acquired from exterior through a communication unit.

Various types of drives may be connected to the control device 60. Examples of the drives include devices that can read data from a computer-readable portable recording medium, such as a flexible disk, a magnetooptical disk, a CD-ROM, a DVD-ROM, or a universal serial bus (USB) memory, and devices that can write data on the recording media. When a drive is provided, a control program may be stored in a portable recording medium and the program may be executed by reading the portable recording medium with a corresponding drive.

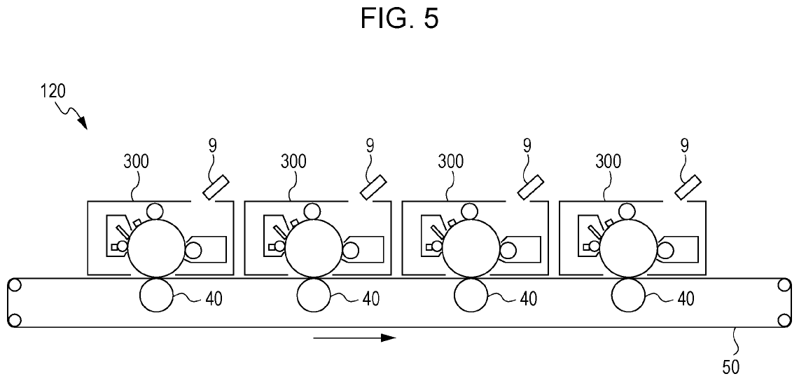

FIG. 5 is a schematic diagram illustrating another example of the image forming apparatus according to this exemplary embodiment.

An image forming apparatus 120 illustrated in FIG. 5 is a tandem-system multicolor image forming apparatus equipped with four process cartridges 300. In the image forming apparatus 120, four process cartridges 300 are arranged in parallel on the intermediate transfer body 50, and one electrophotographic photoreceptor is used for one color. The image forming apparatus 120 is identical to the image forming apparatus 100 except for the tandem system.

The image forming apparatus 100 of this exemplary embodiment is not limited to the structure described above. For example, a first charge erasing device that orients the polarity of the residual toner to facilitate removal with the cleaning brush may be disposed near the electrophotographic photoreceptor 7, and on the downstream of the transfer device 40 in the electrophotographic photoreceptor 7 rotation direction and on the upstream of the cleaning device 13 in the electrophotographic photoreceptor rotation direction. Alternatively, a second charge erasing device that erases charges on the surface of the electrophotographic photoreceptor 7 may be disposed on the downstream of the cleaning device 13 in the electrophotographic photoreceptor rotation direction and on the upstream of the charging device 8 in the electrophotographic photoreceptor rotation direction.

The image forming apparatus 100 of this exemplary embodiment is not limited to the structure described above, and a known structure, for example, a direct transfer-type image forming apparatus, in which a toner image formed on the electrophotographic photoreceptor 7 is directly transferred to a recording medium, may be employed.

### EXAMPLES

The present disclosure will now be specifically described through Examples which do not limit the present disclosure. In the examples below, “parts” means parts by mass.

### Preparation of Silica Particles

### Silica Particles

To 100 parts by mass of untreated (hydrophilic) silica particles “trade name: OX50 (produced by Nippon Aerosil Co., Ltd.), 30 parts by mass of a trimethylsilane compound (1,1,1,3,3,3-hexamethyldisilazane (produced by Tokyo Chemical Industry Co., Ltd.)) is added as a hydrophobizing agent, and the resulting mixture is reacted for 24 hours, followed by filtration, to obtain hydrophobized silica particles. The condensation ratio of the silica particles is 93%. The silica particles have trimethylsilyl groups on the surface. The volume-average particle diameter of the silica particles is 40 nm.

### Example 1

### Preparation of Undercoat Layer

An inorganic protective layer composed of hydrogen-containing gallium oxide is formed on a surface of an aluminum substrate (outer diameter: 30 mm, length: 365 mm, thickness (wall thickness): 1.0 mm) subjected to a honing process. The inorganic protective layer is formed by using a film forming apparatus having the structure illustrated in FIGS. 2A and 2B.

First, the aluminum substrate is placed on the substrate supporting member 213 in the deposition chamber 210 of the film forming apparatus, and the interior of the deposition chamber 210 is vacuum-evacuated through the exhaust port 211 until the pressure reaches 0.1 Pa.

Next, He-diluted 40% oxygen gas (flow rate: 1.4 sccm) and hydrogen gas (flow rate: 50 sccm) are introduced from the gas inlet duct 220 into the high-frequency discharge tube unit 221 in which the flat plate electrode 219 having a diameter of 85 mm is provided; and, by using the high-frequency power supply unit 218 and a matching circuit (not illustrated in FIGS. 2A and 2B), a 13.56 MHz radiowave is set to an output of 150 W and discharging is performed from the flat plate electrode 219 by matching with a tuner. The reflected wave during this process is 0 W.

Next, trimethylgallium gas (flow rate: 1.9 sccm) is introduced through the gas inlet duct 215 from the shower nozzle 216 into the plasma diffusing section 217 inside the deposition chamber 210. During this process, the reaction pressure inside the deposition chamber 210 measured by a Baratron vacuum gauge is 5.3 Pa.

Under this condition, the aluminum substrate is rotated at a speed of 500 rpm while conducting film formation for 300 minutes so as to form an undercoat layer having a thickness of 1.0 μm on the surface of the aluminum substrate.

The element compositional ratio of oxygen to gallium (oxygen/gallium) in the undercoat layer is 1.11.

### Preparation of Charge Generating Layer

A mixture containing 15 parts by mass of hydroxygallium phthalocyanine serving as a charge generating material and having diffraction peaks at least at Bragg's angles (2θ0.2°)) of 7.3°, 16.0°, 24.9°, and 28.0° in an X-ray diffraction spectrum obtained by using CuKα X-ray, 10 parts by mass of a vinyl chloride-vinyl acetate copolymer (VMCH produced by Nippon Unicar Company Limited) serving as a binder resin, and 200 parts by mass of n-butyl acetate is dispersed in a sand mill with glass beads having a diameter ϕ of 1 mm for 4 hours. To the resulting dispersion, 175 parts by mass of n-butyl acetate and 180 parts by mass of methyl ethyl ketone are added and stirred so as to obtain a coating solution for forming a charge generating layer. This coating solution for forming a charge generating layer is applied to the undercoat layer by dip coating, and dried at room temperature (25° C.)) to form a charge generating layer having a thickness of 0.2 μm.

### Preparation of Charge Transporting Layer

To 65 parts by mass of silica particles (1), 250 parts by mass of tetrahydrofuran is added. To the resulting mixture kept at a liquid temperature of 20° C., 17.5 parts by mass of 4-(2,2-diphenylethyl)-4′,4″-dimethyl-triphenylamine and 17.5 parts by mass of a bisphenol Z-type polycarbonate resin (viscosity-average molecular weight: 30000) serving as a binder resin are added, and the resulting mixture is stirred and mixed for 12 hours to obtain a charge-transporting-layer-forming solution.

This charge-transporting-layer-forming solution is applied to the charge generating layer, and dried at 135° C. for 40 minutes to form a charge transporting layer having a thickness of 30 μm, thereby obtaining an electrophotographic photoreceptor.

Through the above-described steps, an organic photoreceptor (1) in which an undercoat layer, a charge generating layer, and a charge transporting layer are stacked on an aluminum substrate in that order is obtained.

Formation of inorganic protective layer Next, an inorganic protective layer composed of hydrogen-containing gallium oxide is formed on a surface of the organic photoreceptor (1). The inorganic protective layer is formed by using a film forming apparatus having the structure illustrated in FIGS. 2A and 2B.

First, the organic photoreceptor (1) is placed on the substrate supporting member 213 in the deposition chamber 210 of the film forming apparatus, and the interior of the deposition chamber 210 is vacuum-evacuated through the exhaust port 211 until the pressure reaches 0.1 Pa.

Next, He-diluted 40% oxygen gas (flow rate: 1.8 sccm) and hydrogen gas (flow rate: 50 sccm) are introduced from the gas inlet duct 220 into the high-frequency discharge tube unit 221 in which the flat plate electrode 219 having a diameter of 85 mm is provided; and, by using the high-frequency power supply unit 218 and a matching circuit (not illustrated in FIGS. 2A and 2B), a 13.56 MHz radiowave is set to an output of 150 W and discharging is performed from the flat plate electrode 219 by matching with a tuner. The reflected wave during this process is 0 W.

Next, trimethylgallium gas (flow rate: 1.9 sccm) is introduced from the gas inlet duct 215 through the shower nozzle 216 into the plasma diffusing section 217 inside the deposition chamber 210. During this process, the reaction pressure inside the deposition chamber 210 measured by a Baratron vacuum gauge is 5.3 Pa.

Under this condition, the organic photoreceptor (1) is rotated at a speed of 500 rpm while conducting film formation for 900 minutes so as to form an inorganic protective layer having a thickness of 3.0 μm on the surface of the charge transporting layer of the organic photoreceptor (1).

The surface roughness Ra of the outer circumferential surface of the inorganic protective layer is 1.9 nm.

The element compositional ratio of oxygen to gallium (oxygen/gallium) in the inorganic protective layer is 1.35.

Through the above-described steps, an electrophotographic photoreceptor of Example 1 in which an undercoat layer, a charge generating layer, a charge transporting layer, and an inorganic protective layer are stacked on a conductive substrate in that order is obtained.

### Examples 2 to 4

Electrophotographic photoreceptors the respective examples are obtained as in Example 1 except that the element compositional ratio (O/Ga), the volume resistivity, and the film elastic modulus are changed as in Table 1.

The element constitutional ratio (O/Ga) and the volume resistivity of the undercoat layer are changed by adjusting the flow rate of the gas used in the film formation and the deposition time, and due to these changes, the film elastic moduli described in Table 1 are obtained.

### Example 5

An electrophotographic photoreceptor is obtained as in Example 3 except that the silica particle content in the charge transporting layer is changed as in Table 1 and the film elastic modulus of the charge transporting layer is changed as in Table 1.

### Examples 6 and 9

Electrophotographic photoreceptors of the respective examples are obtained as in Example 3 except that the thickness of the inorganic protective layer is changed as in Table 1 or 2.

The thickness of the inorganic protective layer is changed by adjusting the flow rates of the various gases used in the film formation and the deposition time as appropriate.

### Examples 7 and 8

Electrophotographic photoreceptors of the respective examples are obtained as in Example 3 except that the thickness of the undercoat layer is changed as in Table 2.

The thickness of the inorganic protective layer is changed by adjusting the flow rates of the various gases used in the film formation and the deposition time as appropriate.

### Comparative Example 1

An electrophotographic photoreceptor is obtained as in Example 3 except that the silica particles are not used in the charge transporting layer and that the film elastic modulus of the charge transporting layer is changed as in Table 1.

### Comparative Example 2

An electrophotographic photoreceptor is obtained as in Example 6 except that the silica particles are not used in the charge transporting layer and that the film elastic modulus of the charge transporting layer is changed as in Table 1.

### Evaluation

### Evaluation of Dents

The electrophotographic photoreceptors obtained in the respective examples are each loaded to an image forming apparatus (DocuCentre-V C7775 produced by Fuji Xerox Co., Ltd.)) and the following evaluation is conducted.

After an all halftone image with an image density of 30% is continuously output onto one million A4 paper sheets (in other words, the number of rotation of the electrophotographic photoreceptor is 3 million) in an environment having a temperature of 20° C. and a humidity of 40% RH, the surface of the electrophotographic photoreceptor (in other words, the surface of the inorganic protective layer) is observed with an optical microscope (model No. VHX produced by KEYENCE CORPORATION) at a magnification of 450× in 10 areas of view to count the number of dents to calculate the number of dents (hereinafter may be referred to as the “dent number”) per unit area (1 mm×1 mm).

The evaluation standard is as follows. The results are indicated in Tables 1 and 2 (in the columns “Dents” in Tables 1 and 2).

### Evaluation Standard

A: The dent number is 1 or less.

B: The dent number is more than 1 but not more than 3.

C: The dent number is more than 3 but not more than 5.

D: The dent number is more than 5 but not more than 10.

E: The dent number is more than 10.

### Evaluation of Image Density

The image density of the first image and that of the a millionth image output for dent evaluation are compared with naked eye and evaluated.

The evaluation standard is as follows, and the results are indicated in Tables 1 and 2 (in the columns “Image density” in Tables 1 and 2).

### Evaluation Standard

A: There is no difference in image density.

B: There is a slight difference in image density.

C: There is a region where a difference in image density is observed.

D: There is a clear difference in image density.

TABLE 1

| | | | | | Charge transporting layer | | | | | | | |
|---|---|---|---|---|---|---|---|---|---|---|---|---|
| | Undercoat layer | | | | | Silica | Inorganic protective layer | | | | | |
| | Film elastic | | Volume | | Film elastic | particle | Film elastic | | Volume | | Evaluation | |
| | modulus | | resistivity | Thickness | modulus | content | modulus | | resistivity | Thickness | | Image |
| | [GPa] | O/Ga | [Ω · cm] | [μm] | [GPa] | [mass %] | [GPa] | O/Ga | [Ω · cm] | [μm] | Dents | density |
| Example 1 | 80 | 1.11 | 1 × 10⁷ | 1 | 15 | 65 | 100 | 1.35 | 1 × 10⁹ | 3 | A | B |
| Example 2 | 90 | 1.22 | 1 × 10⁸ | 1 | 15 | 65 | 100 | 1.35 | 1 × 10⁹ | 3 | A | A |
| Example 3 | 100 | 1.35 | 1 × 10⁹ | 1 | 15 | 65 | 100 | 1.35 | 1 × 10⁹ | 3 | A | A |
| Example 4 | 105 | 1.45 | 1 × 10¹⁰ | 1 | 15 | 65 | 100 | 1.35 | 1 × 10⁹ | 3 | B | B |
| Example 5 | 100 | 1.35 | 1 × 10⁹ | 1 | 7 | 50 | 100 | 1.35 | 1 × 10⁹ | 3 | B | B |
| Example 6 | 100 | 1.35 | 1 × 10⁹ | 1 | 15 | 65 | 100 | 1.35 | 1 × 10⁹ | 1 | C | C |
| Comparative | 100 | 1.35 | 1 × 10⁹ | 1 | 4 | 0 | 100 | 1.35 | 1 × 10⁹ | 3 | D | D |
| Example 1 | | | | | | | | | | | | |
| Comparative | 100 | 1.35 | 1 × 10⁹ | 1 | 4 | 0 | 100 | 1.35 | 1 × 10⁹ | 1 | E | D |
| Example 2 | | | | | | | | | | | | |

TABLE 2

| | | | | | Charge transporting layer | | | | | | | |
|---|---|---|---|---|---|---|---|---|---|---|---|---|
| | Undercoat layer | | | | | Silica | Inorganic protective layer | | | | | |
| | Film elastic | | Volume | | Film elastic | particle | Film elastic | | Volume | | Evaluation | |
| | modulus | | resistivity | Thickness | modulus | content | modulus | | resistivity | Thickness | | Image |
| | [GPa] | O/Ga | [Ω · cm] | [μm] | [GPa] | [mass %] | [GPa] | O/Ga | [Ω · cm] | [μm] | Dents | density |
| Example 7 | 100 | 1.35 | 1 × 10⁹ | 0.5 | 15 | 65 | 100 | 1.35 | 1 × 10⁹ | 3 | A | A |
| Example 8 | 100 | 1.35 | 1 × 10⁹ | 2 | 15 | 65 | 100 | 1.35 | 1 × 10⁹ | 3 | A | A |
| Example 9 | 100 | 1.35 | 1 × 10⁹ | 1 | 15 | 65 | 100 | 1.35 | 1 × 10⁹ | 5 | A | A |

In Tables 1 and 2, Ga+O indicates the sum of the element constitutional ratios of gallium and oxygen relative to all elements constituting the inorganic protective layer.

The results indicate that in Examples, occurrence of dents is suppressed and the difference in image density is small compared to Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An electrophotographic photoreceptor comprising:
a conductive substrate;
an undercoat layer on the conductive substrate;
a charge generating layer on the undercoat layer;
a charge transporting layer on the charge generating layer; and
an inorganic protective layer on the charge transporting layer,
wherein the undercoat layer, the charge transporting layer, and the inorganic protective layer each have a film elastic modulus of 5 GPa or more.

2. The electrophotographic photoreceptor according to claim 1, wherein a difference in film elastic modulus between the undercoat layer and the inorganic protective layer is 60 GPa or less.

3. The electrophotographic photoreceptor according to claim 1, wherein a difference in film elastic modulus between the charge transporting layer and the inorganic protective layer is 90 GPa or less.

4. The electrophotographic photoreceptor according to claim 1, wherein the inorganic protective layer has a film elastic modulus of 40 GPa or more and 120 GPa or less.

5. The electrophotographic photoreceptor according to claim 1, wherein the charge transporting layer has a film elastic modulus of 6 GPa or more and 7 GPa or less.

6. The electrophotographic photoreceptor according to claim 1, wherein the undercoat layer has a film elastic modulus of 80 GPa or more and 120 GPa or less.

7. An electrophotographic photoreceptor comprising:
a conductive substrate;
an undercoat layer on the conductive substrate, the undercoat layer being formed of a metal oxide layer;
a charge generating layer on the undercoat layer;
a charge transporting layer on the charge generating layer, the charge transporting layer containing a binder resin, a charge transporting material, and silica particles; and
an inorganic protective layer on the charge transporting layer, the inorganic protective layer being formed of a metal oxide layer.

8. The electrophotographic photoreceptor according to claim 7, wherein the undercoat layer is formed of a metal oxide layer containing gallium and oxygen.

9. The electrophotographic photoreceptor according to claim 7, wherein the inorganic protective layer is formed of a metal oxide layer containing gallium and oxygen.

10. The electrophotographic photoreceptor according to claim 7, wherein the inorganic protective layer has a thickness of 1.0 μm or more and 10 μm or less.

11. The electrophotographic photoreceptor according to claim 10, wherein the inorganic protective layer has a thickness of 3.0 μm or more and 10 μm or less.

12. The electrophotographic photoreceptor according to claim 7, wherein a content of the silica particles relative to the charge transporting layer is 30 mass % or more and 70 mass % or less.

13. The electrophotographic photoreceptor according to claim 12, wherein the content of the silica particles relative to the charge transporting layer is 50 mass % or more and 70 mass % or less.

14. A process cartridge detachable from and attachable to an image forming apparatus, the process cartridge comprising the electrophotographic photoreceptor according to claim 1.

15. An image forming apparatus comprising:
the electrophotographic photoreceptor according to claim 1;
a charging unit that charges a surface of the electrophotographic photoreceptor;
an electrostatic latent image-forming unit that forms an electrostatic latent image on the charged surface of the electrophotographic photoreceptor;
a developing unit that develops the electrostatic latent image on the surface of the electrophotographic photoreceptor by using a developer containing a toner so as to form a toner image; and
a transfer unit that transfers the toner image onto a surface of a recording medium.
